(19) United States
(12) Patent Application Publication
(10) Pub. No.: US 2013/0046679 A1
(43) Pub. Date: Feb. 21, 2013

(54) JOINT PAYMENT

(71) Applicant: Paul Davoust, Louisville, CO (US)

(72) Inventor: Paul Davoust, Louisville, CO (US)

(73) Assignee: CARINGFAMILY, LLC, Louisville, CO (US)

(21) Appl. No.: 12/690,108

(22) Filed: Jan. 19, 2010

Related U.S. Application Data
(63) Continuation-in-part of application No. 11/381,974, filed on May 5, 2006, now Pat. No. 7,650,069.
(60) Provisional application No. 60/678,349, filed on May 6, 2005.

(51) Int. Cl. G06Q 20/22

(52) U.S. Cl. 705/39

(57) ABSTRACT

Methods and systems for facilitating various e-commerce joint payment scenarios are provided. According to one embodiment, a computer system of a communication service provider receives payment information from a first member of a caregroup that shall serve as a primarily responsible individual for periodic service fees associated with communication services provided by the communication service provider to a digital mailbox appliance of a second member of the caregroup. Responsive to a request by the primarily responsible individual, the computer system enables the periodic service fees to be shared by other members of the caregroup by allowing one or more of the other members of the caregroup to commit to payment of a portion of the periodic service fees as secondarily responsible individuals.

### CROSS-REFERENCE TO RELATED APPLICATIONS

This application is a continuation-in-part of U.S. patent application Ser. No. 11/381,974, filed May 5, 2006, which claims the benefit of U.S. Provisional Application No. 60/678,349, filed on May 6, 2005, both of which are hereby incorporated by reference in their entirety for all purposes. This application may be related to the subject matter of co-pending U.S. patent application Ser. Nos. 10/971,916 and 10/972,000 both filed on Oct. 23, 2004 and both of which are hereby incorporated by reference in their entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2005-2010, CaringFamily, LLC

### BACKGROUND

1. Field

Embodiments of the present invention generally relate to Internet e-commerce (e.g., the purchasing of goods and/or services via the Internet), and in particular, to joint payment of recurring, installment and/or subscription service fees that are automatically authorized in accordance with predefined authorization instructions of the parties, such as, to authorize to be charged to credit cards of multiple individuals, the communication service access fees of a third party.

2. Description of the Related Art

The proliferation of e-commerce web sites has enabled users to purchase goods and/or services directly over the World Wide Web. E-commerce web sites typically include an electronic shopping cart or similar construct to track user selected goods and/or service until the purchaser checks out and provides payment information and shipping information. Although the shopping cart model is very flexible and intuitive, it has limitations. For example, the traditional shopping cart model provides no mechanism to facilitate contribution to the purchase or otherwise sharing of responsibility of payment for an item or items by multiple individuals.

### SUMMARY

Methods and systems are described for facilitating various e-commerce joint payment scenarios. According to one embodiment, a joint payment method is provided. A computer system of a communication service provider receives payment information from a first member of a caregroup that shall serve as a primarily responsible individual for periodic service fees associated with communication services provided by the communication service provider to a digital mailbox appliance of a second member of the caregroup. Responsive to a request by the primarily responsible individual, the computer system enables the periodic service fees to be shared by other members of the caregroup by allowing one or more of the other members of the caregroup to commit to payment of a portion of the periodic service fees as secondarily responsible individuals.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 conceptually illustrates a family private network service of a communication service provider with which various embodiments of the present invention may operate.

FIG. 2 is a simplified block diagram illustrating various functional units of an e-commerce web site according to one embodiment of the present invention.

FIG. 3 illustrates a shared billing screen shot according to one embodiment of the present invention.

FIG. 4 is a flow diagram illustrating shared billing registration processing according to one embodiment of the present invention.

FIG. 5 is a flow diagram illustrating payment processing according to one embodiment of the present invention.

FIG. 6A illustrates a shopping cart enhanced with joint payment capabilities in accordance with an embodiment of the present invention.

FIG. 6B illustrates a shared buy page in accordance with an embodiment of the present invention.

FIG. 7 is a flow diagram illustrating joint payment invitation processing according to one embodiment of the present invention.

FIG. 8 is a flow diagram illustrating joint payment acceptance processing according to one embodiment of the present invention.

FIG. 9 illustrates a computer system suitable for use, in accordance with an embodiment of the present invention.

### DETAILED DESCRIPTION

Methods and systems are described to facilitate various e-commerce joint payment scenarios. According to one embodiment, a joint payment method is provided that facilitates the management of automated recurring payments for a communications service by (i) gaining commitment of a primary buyer, and (ii) optionally gaining additional member payer commitments to cover a portion of the typically monthly service fees that is then deducted from the primary buyer commitment.

According to one embodiment, a digital mailbox system is provided to facilitate receipt and transmission of electronic communications without requiring the end user to have a personal computer. According to one embodiment, a digital mailbox system facilitates receipt and transmission of electronic communications without requiring the end user to have a personal computer. The digital mailbox system includes a novel architecture through which the various interacting parties may use an electronic communication access system that suits their particular needs and technological comfort level thereby adding grace back to the lives of both the elder and their social support network. The novel architecture may provide various tools and applications to promote communications among members of a social support network. For example, according to one embodiment, collaborative and/or individual publishing tools are provided via a website interface to enable collaborative and/or individual development of a daily delivery of a digital publication, such as a newsletter-like publication or the like, for communication to elders by friends, caregivers, family and volunteers. In one embodiment, members of a social support network may select and/or customize content for inclusion in the digital publication from various predefined data streams (e.g., jokes, business news, global news, local news, sports news, puzzles, cartoons, weather, etc.) based upon interests, hobbies and/or cognitive needs (e.g., intellectual stimulation) of the intended recipient. For example, the kinds of material typical of newspaper syndicated features can be provided, such as horoscope, literary quote of the day, “on this day in history”, “in your garden today”, and the like, selected by the members of the elder's social support network to be appropriate to the elder's interests. In one embodiment, members of a social support network may create or harvest existing family content, such as digitized photos, daily deliveries, digitized art created by children (a/k/a “kid art”), and use it to create various compositions to share among one another and/or the digital mailbox appliance user.

Meanwhile, an elder may make use of a dedicated hardcopy device for sending and receiving electronic communications without the need for a computer, keyboard or mouse. In this manner, the novel architecture acts as a communications transformer by receiving electronic communications in one form from the originator of the communication and outputting the electronic communication in a form suitable for access by an intended recipient thereby facilitating communication to and from those disinclined or unable to use computers, the internet, and/or home networks.

Embodiments of the present invention include various steps, which will be described below. The steps may be performed by hardware components or may be embodied in machine-executable instructions, which may be used to cause a general purpose or special-purpose processor programmed with the instructions to perform the steps. Alternatively, the steps may be performed by a combination of hardware, software, customer service personnel associated with a communication service provider, caregroup members serving in a customer service role and/or firmware.

Embodiments of the present invention may be provided as a computer program product, which may include a machine-readable medium having stored thereon instructions, which may be used to program a computer (or other electronic devices) to perform a process. The machine-readable medium may include, but is not limited to, floppy diskettes, optical disks, compact disc read-only memories (CDROMs), and magneto-optical disks, ROMs, random access memories (RAMS), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While according to one embodiment, a digital mailbox system is described as a communication mechanism among families and elders, other embodiments of the digital mailbox system are equally applicable to facilitating electronic communications to and from other groups of individuals, such as developmentally disabled adults. Furthermore, the communications may include unrelated individuals within a common social support network

While, for convenience, embodiments of the present invention are described with reference to an Application Service Provider (ASP) model, embodiments of the present invention are equally applicable to various other operational models. For example, the systems and methods described herein may be deployed in accordance with a model in which the application is hosted internally by an organization and made accessible to various distributed locations of the organization.

Finally, while for sake of illustration, embodiments of the present invention are described with reference to joint payment scenarios involving sharing of recurring communication service fees, embodiments of the present invention are equally applicable to various other transactions, including, but not limited to the online purchase of goods (e.g., consumer electronics, durable goods, books, etc.). Similarly, while embodiments of the present invention are described in relation to a shared buy being initiated by a primary payer in the context of a shopping cart, it is to be understood that a non-payer, such as a prospective recipient, may initiate the shared buy process via an e-commerce web site “wish list,” online gift registry, or the like. In this manner, a person desiring a particular item or items may do the shopping on behalf of a group of sharing payers and allow the group to pay for the desired item(s).

### Terminology

Brief definitions of terms used throughout this application and attached appendix are given below.

The phrase “administrating caregiver” generally refers to a member of a caregroup that has certain administrative privileges within the communication system platform. In one embodiment, administrating caregivers have access and permissions to operate a communications service dashboard. Administrating caregivers may have the ability to add or remove members to the caregroup, update family data, manage member viewing, editing and notification permissions, originate coaching prompts, configure many of the VPN and digital mailbox appliance behaviors like time of elder's daily delivery, default printing font, etc. Caregroups may have one or more administrating caregivers.

The terms “caregroup” and “members” and the phrases “social support network” and “family support network” generally refer to a collection of individuals, including family, friends, caregivers, volunteers and/or service providers, who are registered members of a VPN associated with a user of communication appliance, such as a digital mailbox appliance. An individual may be a member of multiple caregroups. Members may have different viewing, editing and notification permissions independently associated with each caregroup in which they participate. For example, administrative caregiver permissions described above are one such set of permissions.

The terms “connected” or “coupled” and related terms are used in an operational sense and are not necessarily limited to a direct connection or coupling. The phrase “content derived addressing” generally refers to a process that permits a user of a communication appliance, such as a hardcopy-based email appliance, to send a message to one or more caregroup members without having to specify an email address, phone number or the like. Rather, the message itself contains sufficient information to allow a communication service provider to determine the intended addressee(s). According to one embodiment, with a single press of a button on a hardcopy-based communication appliance an elder may have a message delivered electronically to any caregroup member as part of an email message.

The phrase “digital mailbox appliance” generally refers to a communication appliance or component configured to be associated with a caregroup VPN through a closed communication service. In one embodiment, a digital mailbox appliance is a hardcopy-based communication appliance that (i) accepts hardcopy input, e.g., paper-based messages, and creates a digital representation of the hardcopy input for electronic delivery, e.g., email delivery of such digital representation or digital gifts based on such digital representation, to one or more members of the caregroup associated with the digital mailbox appliance; and (ii) creates hardcopy output, e.g., paper-based messages, responsive to electronic delivery of communications from caregroup members that are directed to the user of the digital mailbox appliance. According to one embodiment, digital mailbox appliances are remotely maintained by a communication service provider responsive to calls to the communication service provider initiated by the digital mailbox appliances. Depending upon the particular embodiment, a digital mailbox appliance is both simpler than a multifunction printer (MFP) and more functional than an MFP. According to one embodiment, a digital mailbox appliance is simpler than an MFP in that it excludes many MFP features, such as a copier, a universal serial bus (USB) connection to and operation with a PC (or network of PC's), local control of quality (print and scan). According to one embodiment, a digital mailbox appliance is more functional than a MFP in that it connects to and depends on a closed communication service, in that it schedules daily printing, in that it connects to the closed communication service at a time of it's choosing (modem management based on local configuration). It is envisioned that a digital mailbox appliance may be embedded within other consumer devices, such as printers, fax machines, or the like. Also, in embodiments in which hardcopy output is not desired or needed, the digital mailbox appliance may comprise or be part of a cell phone, a personal digital assistant (PDA), or other current or future handheld wireless devices.

The term “elder” generally refers to an aging family member, such as a parent or grand parent. Typically, the elder is the user of a digital mailbox appliance and a center of focus of a social support network, such as a caregroup, and a target recipient of communication services. An elder might also be an isolated or disabled family member.

The phrase “ex-officio member” generally refers to a member of a caregroup that has been granted access because of some commercial or support group relationship to the caregroup. Without limitation, examples include the entity or organization that provides the communication service, church groups (e.g., the elder's shut-in committee of their church), an “attending” home care agency, supporting personnel in an assisted living situation, physician, nurse, physician's assistant, insurance provider, etc. Ex-officio members typically have access to specialized customer support tools (though a communication service provider customer services website). The tools available and access to information within them may be configured for each caregroup-ex-officio role.

The phrase “helper member” generally refers to a volunteer or commercial caregiver with member status within a caregroup permitted by the administrating caregiver. Examples of helper members include members of a church group, employees of a home care agency, a geriatric consultant, or members of a specialized supporting group (e.g., for Alzheimer' s care).

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

The phrase “joint payment” generally refers to a mechanism that permits multiple individuals to share the cost of goods and/or services. According to one embodiment of the present invention, joint payment may be used by members of a caregroup to pay and independently manage a recurring service subscription on behalf of the target of the caregroup. In other embodiments, family, friends, co-workers and the like may use joint payment to purchase a big ticket item (e.g., an iPod Touch, a Wii console, a flat screen TV, etc.) for a recipient.

If the specification states a component or feature “may”, “can”, “could”, or “might” be included or have a characteristic, that particular component or feature is not required to be included or have the characteristic.

The term “responsive” includes completely or partially responsive.

Embodiments of the present invention provide methods and systems for creating a virtual private network (VPN) connecting non-computer users with their social support networks who do use computers and/or email appliances. In one embodiment, coaching techniques are employed to influence the quantity, quality, effectiveness and timeliness of electronic communications to and from individuals frequently isolated from family and friends.

Information technology methods and systems are described herein that seek to empower participants in a social support network by simplifying the task of creating and initiating communications. In the context of various embodiments described herein the methods and systems seek to allow family members to provide more effective support to an elder living independently. For example, various communications tools make it easier for family caregivers to provide stimulating and useful information to the elder, helping to sustain health, activity and engagement. Embodiments of the present invention operate as a communication transformer making it possible for family members to communicate with elders using the Internet, without requiring the elders to operate or maintain a computer. It is contemplated that the methods and systems described herein will make it easier for family caregivers to share information and ideas among themselves, and increase the general level of communication within the family generally as well as to and from the elder.

In one embodiment, a device or set of devices referred to as a “digital mailbox” or a “digital mailbox appliance” allows electronic communication with elders. The digital mailbox provides a much simpler user interface for the elder than email or other existing computer applications. The digital mailbox may incorporate features of a fax machine, a photo printer, and a scanner, backed by servers operated by a communication service provider. A member of a social support network is able to generate email or create a digital gift or contribute to a periodic publication which is delivered to the elder as a high-quality hardcopy with no intervention required by the elder via the communication service provider. According to one embodiment, the elder can send correspondence to a member of his/her social support network from his/her digital mailbox by simply placing it on a flat scanner bed and pressing a single button. No typing or dialing is required. For example, addressing of the correspondence may be accomplished by checking off address information on a routing form provided by the communication service provider and customized for the elder.

According to one embodiment of the present invention, a communication system in which the digital mailbox operates provides an online interface, such as a password protected portion of a web portal, into which participants in a social support group may login. The communication system may include various automated communication tools that allow family members or others in an elder's social support network to send engaging, interesting and useful information to the elder. The communication system web site may also include an area for managing account information, including, but not limited to, billing and payment information.

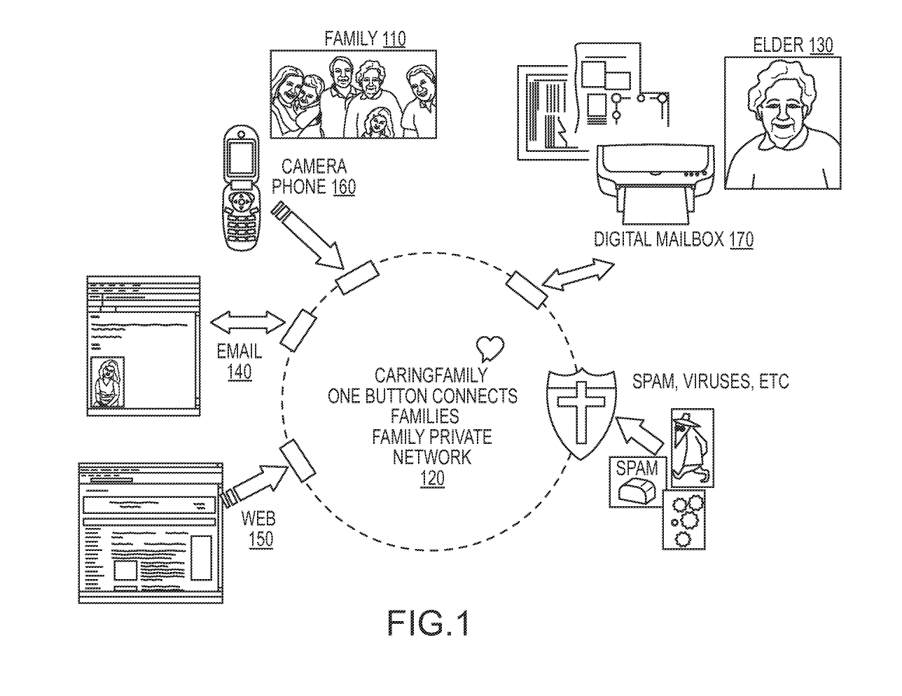

FIG. 1 conceptually illustrates a family private network service 100 of a communication service provider with which various embodiments of the present invention may operate. Advantageously, according to the embodiment depicted, each participating family member 110 can interface with the family private network 120 via electronic services gateways with which they are familiar. For example, an elder 130 may receive email 140 and web pages 150 by way of hard copy output from a digital mailbox 170. Meanwhile, other family members may provide content, in the form of digital pictures, for example, to the family private network 120 by way of a hand held device, such as a camera phone 160.

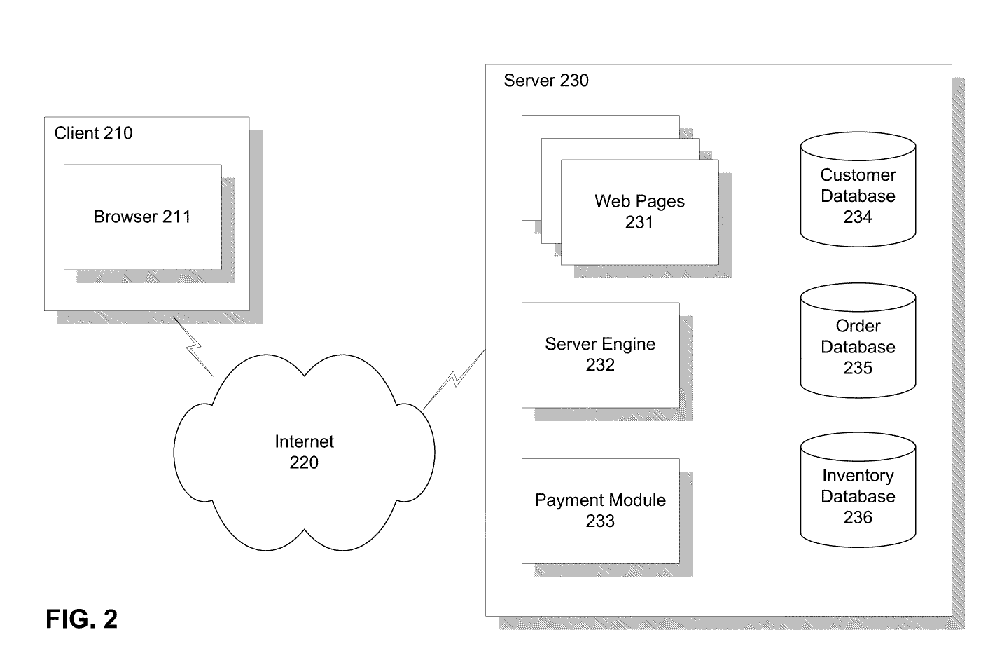

FIG. 2 is a simplified block diagram illustrating various functional units of an e-commerce web site according to one embodiment of the present invention. In the present example, a server system 230 includes a server engine 232, various Web pages 231, a customer database 234, an order database 235, and an inventory database 236. The server engine 232 receives HyperText Transfer Protocol (HTTP) requests to access

Web pages identified by Uniform Resource Locators (URLs) and provides the Web pages to the various client systems (e.g., client 210). Such an HTTP request may indicate that a purchaser has expressed a desire to share the cost of goods and/or services as described further below. In one embodiment, the customer database 234 contains customer information for various purchasers and/or potential purchasers. The customer information may include purchaser-specific order information such as the name of the customer, billing information and shipping information. The order database 235 may contain an entry for each order that has not yet been shipped to a purchaser. The inventory database 236 may contain a description of the various items that may be ordered via the e-commerce web site.

The client system 210 contains a browser 211. The server 230 and client 210 interact by exchanging information via the Internet 220. Those skilled in the art will appreciate that the joint payment techniques described herein can be initiated in different manners than described herein. For example, joint payment can also be initiated in an electronic mail environment in which an item is described in an electronic mail message along with an indication of the joint payers and their payment information. Also, various communication channels may be used such as local area network, wide area network, or point-to-point dial up connection. Also, a server system may comprise any combination of hardware or software that can process or cause to be processed payment transactions. A client system may comprise any combination of hardware or software that can interact with the server system. These systems may include television-based systems or various other consumer products through which orders may be placed.

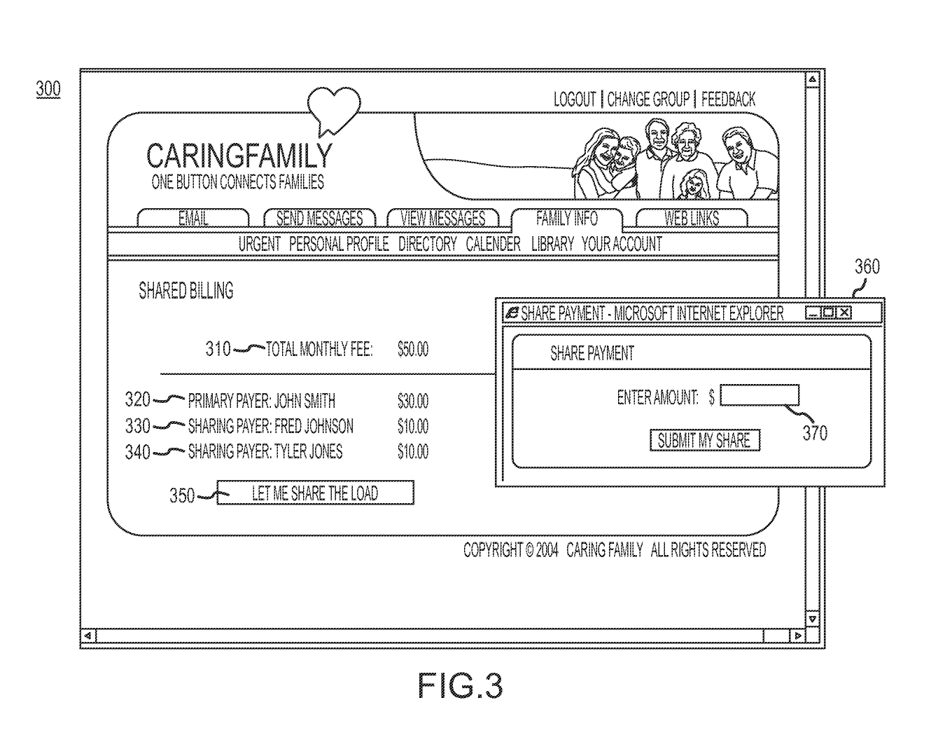

FIG. 3 illustrates a shared billing screen shot 300 according to one embodiment of the present invention. Unique problems arise in the context of a closed communication service which is configured to facilitate and encourage communications among the members of a caregroup and a target of the caregroup, such as an elder. For example, typically, the elder is not the purchaser of such a service. The purchaser of such a service is typically one or more members of an elder's social support network. Embodiments of the present invention, allow members to share the financial burden of the recurring communication service fees and/or the cost of the digital mailbox system.

According to the present example, a monthly bill for a communication service provider is displayed to members of a caregroup that may wish to share the load. A primary buyer (payer) and current sharing payers are displayed along with current payment responsibilities. In one embodiment, the logged-in member can initiate, remove, or modify their own payment commitment (amount or mechanism), but not that of others. Such commitment may be maintained going forward until changed by the member or until the service is deactivated. In one embodiment, the primary payer is legally responsible for the entire monthly service fee reduced by any amount paid by sharing payers. Consequently, in such an embodiment, the last man out rule applies to the primary buyer (payer). That is, if one or more sharing payers drop out, the primary buyer must cover the potion of the total monthly fee previously committed to be paid by the one or more former sharing payers. In one embodiment, if and when payment problems arise, the caregroup members serving as primary or sharing payers may be personally notified by email and requested to revise their responsibility, e.g., delete commitment or revise credit card information. In one embodiment, service billing to primary and sharing payers may be staggered. For example, the primary payer may not be billed until X days after sharing payers.

According to one embodiment, a primary payer of the communication services enables shared billing functionality, which allows authorized members (e.g., non-minors) to sign-up (volunteer) for an auto payment commitment. In embodiments in which the primary payer is primarily responsible for the recurring communication service fees and/or the cost of the digital mailbox system, the primary payer is billed if any payments on the part of the sharing payers cannot be executed successfully.

In one embodiment, ex-officio members can also be joint payers. A special accounting component may be provided within the communication service to give such helper agencies credits to support needy families by whatever criteria they deem appropriate. Some “helper agency” ex-officio members may earn credits by signing up caregroups within the communication service, for example. These credits can be used to offset portions of monthly subscription payments in the same manner as any caregroup member. Such members may be notified as they approach exhausting their credits.

In one embodiment, the primary payer 320 selects to share the load on the family caregroup web site and commits to auto payment by providing credit card information. The primary payer 320 may then optionally invite sharing payers (individually or by a group announcement via the communication service, for example). The shared billing screen 300 then becomes available to authorized sharing payers.

According to one embodiment, sharing payers nominate themselves and the amounts they will auto pay by using the shared billing screen 300. According to the present example, the shared billing screen 300 identifies a total monthly fee 310 for the communication service as well as the name and commitment for a primary payer 320 and one or more sharing payers 330 and 340. The shared billing screen 300 also includes a “Let me Share the Load” button 350, which can be selected by an authorized caregroup member to contribute to the total monthly fee 310. According to one embodiment, the primary payer 320 and sharing payers 330 and 340 can initiate, remove or modify their own payment commitment (amount and/or mechanism). In one embodiment, the commitment is on a going forward basis until it is changed (by the member or the service is cancelled). As described further below, members may be notified by email or other means regarding their own payment problems and requested to revise their responsibility (e.g., delete commitment or revise credit card or payment account information). According to one embodiment, the primary payer 320 is responsible for any portion of the total monthly fee 310 not covered by the sharing payers 320 and 330 (as a result of reduced commitment, deleted commitment, inability on the part of the communication service to process the committed payment or otherwise). The primary payer 320 may be billed a predetermined or configurable number of days after payment processing for the sharing payers 330 and 340 has been completed or attempted.

According to the present example, selection of the “Let me Share the Load” button 350 by a member of the caregroup that desires to be a sharing payer generates a pop-up window 360 into which payment information can be entered, including an amount 370, credit card, etc. After the sharing payer confirms his/her payment information, the shared billing screen 300 is updated to display the new sharing payer.

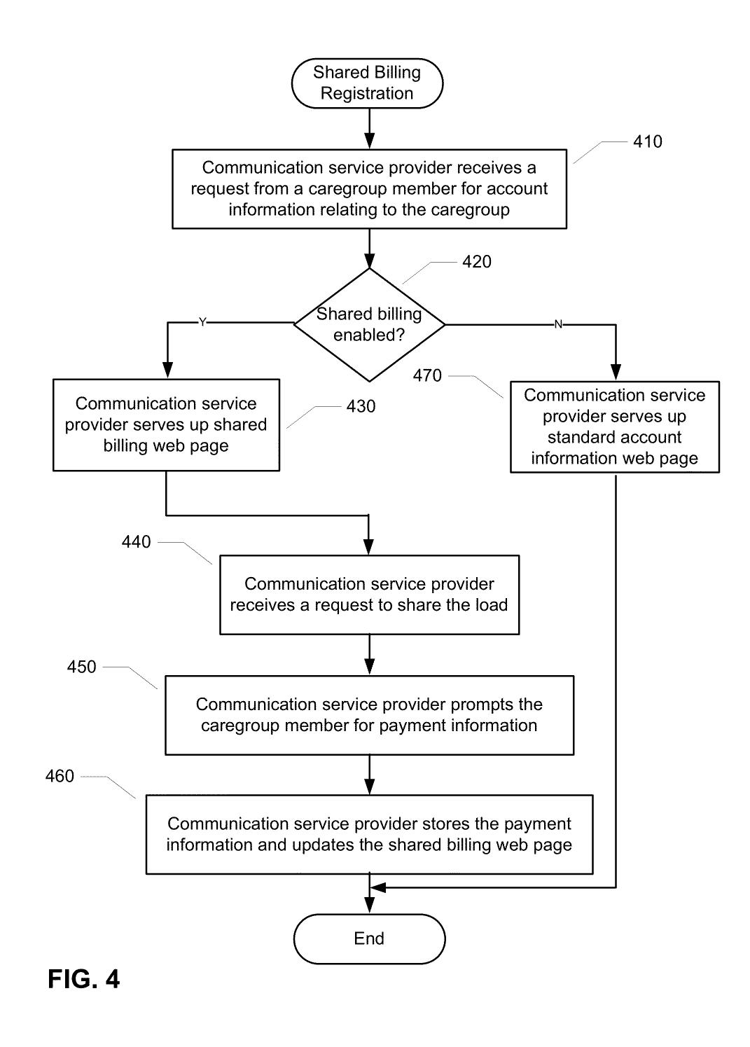

FIG. 4 is a flow diagram illustrating shared billing registration processing according to one embodiment of the present invention. According to the present example, shared billing registration processing begins with block 410. At block 410, a request for account information relating to the caregroup is received by the communication service provider (e.g., by payment module 233) from an authorized member of the caregroup.

At decision block 420, a determination is made regarding whether shared billing is enabled. If so, then processing continues with block 430; otherwise processing branches to block 470.

At block 470, the communication service provider (via server engine 232, for example) serves up the standard account information web page (e.g., one including no shared payers) and shared billing registration processing is complete.

At block 430, the communication service provider (via server engine 232, for example) serves up a shared billing web page (e.g., shared billing screen 300).

At block 440, the communication service provider receives a request by a prospective sharing payer to share the load. Responsive thereto, at block 450, the communication service provider prompts the prospective sharing payer for electronic payment (e-payment) information.

Upon receipt of the e-payment information (e.g., credit card (e.g., Visa, MasterCard, Discover, Diners Club and the like), charge card (e.g., American Express), electronic funds transfer (EFT), Automated Clearing House (ACH), electronic check (echeck), PayPal payment system or other electronic payment system account number), at block 460, the communication service provider stores the e-payment information and updates the shared billing web page.

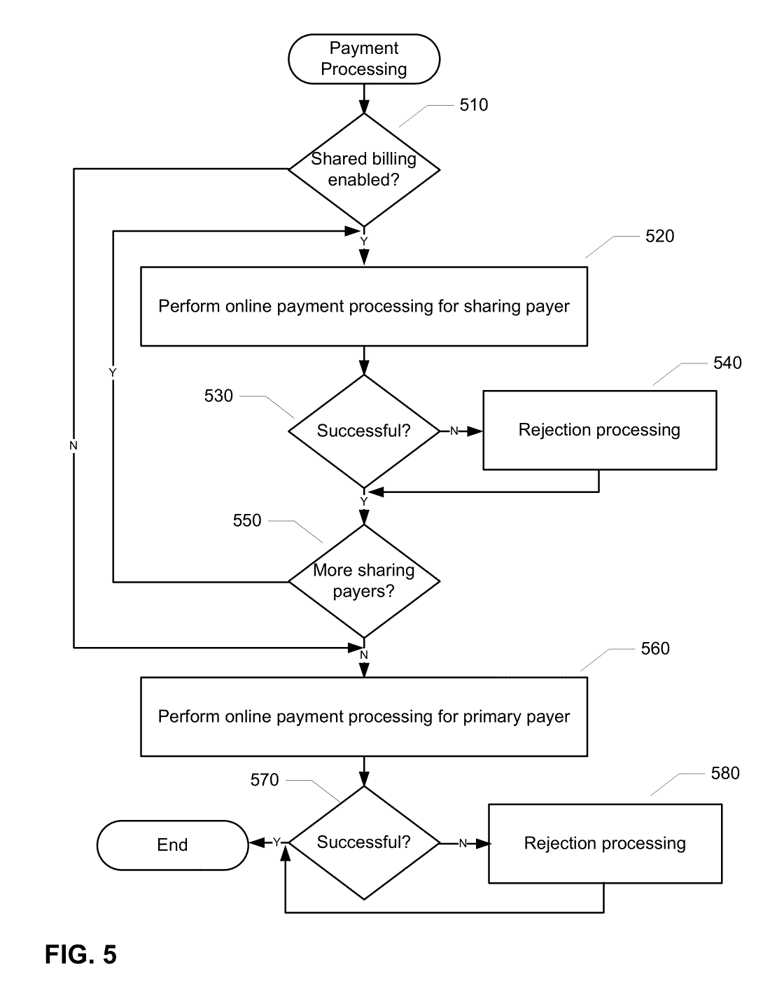

FIG. 5 is a flow diagram illustrating payment processing according to one embodiment of the present invention. In the present example, payment processing is assumed to be performed in batch mode. That is, the payment processing for all payers, the primary payer and the sharing payers, is performed at a predetermined or configurable time subsequent to the time at which the payment information is received, such as in the case of processing a recurring subscription payment.

At decision block 510, a determination is made regarding whether shared billing is enabled. If so, then processing continues with block 520; otherwise, processing branches to block 560.

At block 520, online payment processing is performed for the first sharing payer in accordance with the particular type of e-payment. Such processing may be performed by the e-commerce site or may be outsourced.

At decision block 530, it is determined whether the payment was processed successfully. If so, then processing continues with decision block 550; otherwise, processing branches to block 540.

At block 540, rejection processing is performed. Various options exist for responding to an unsuccessful processing of a payment. For example, if the primary payer is to remain primarily responsible for the transaction at issue, then the amount of the payment that was not processed successfully can be added to the balance to be paid by the primary payer. Alternatively, the amount of the payment that was not processed successfully can be split equally among the remaining payers subject to limits preauthorized by such remaining payers. In any case, a notification (e.g., email or paper-based) may be sent to one or both of the sharing payer associated with the unsuccessfully processed payment and the primary payer.

At decision block 550, it is determined whether there are more sharing payers for which payments need to be processed. If there are additional sharing payers, then processing loops back to block 520 where the payment is processed for the next sharing payer; otherwise, processing continues with block 560.

At block 560, payments for all sharing payers have been processed (successfully or unsuccessfully), now, online payment processing is performed for the primary payer. In implementations in which the primary payer is primarily responsible for the transaction at issue, any amounts associated with unsuccessfully processed payments of the sharing payers are added to the balance due by the primary payer.

At decision block 570, it is determined whether the primary payer's payment was processed successfully. If so, then payment processing is complete; otherwise, processing branches to block 580.

At block 580, rejection processing is performed. Various options exist for responding to an unsuccessful processing of the primary payer's payment. In one embodiment, a secondary form of e-payment may be attempted. Alternatively or additionally, a notification (e.g., email or paper-based) may be sent to the primary payer regarding the failed payment processing attempt.

It will be appreciated by those skilled in the art that the particular ordering of the steps described in connection with the present example are not necessary in various implementations. For example, in implementations in which the primary payer simply represents the initial payer to register for shared billing and is not primarily responsible for the transaction at issue, the primary payer's payment need not be processed last.

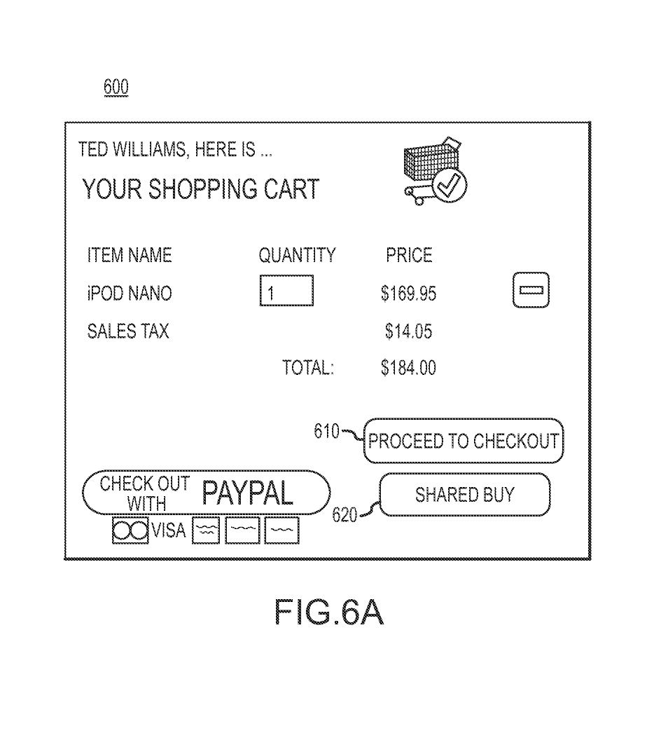

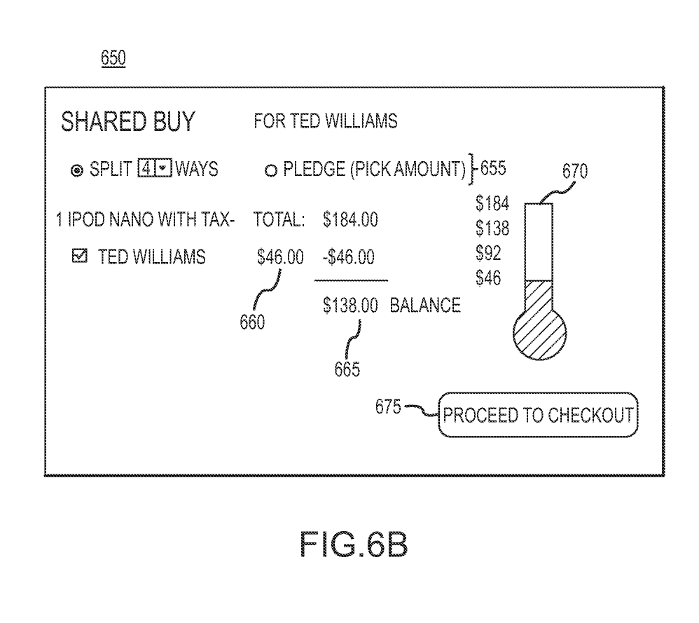

FIG. 6A illustrates a shopping cart 600 enhanced with joint payment capabilities in accordance with an embodiment of the present invention. In the present example, the shopping cart functions in the usual manner, but for the inclusion of a “Shared Buy” button 620. For example, the shopping cart identifies the items currently contained in the cart, items can be removed and quantities can be increased or decreased. The purchaser may select a “Proceed to Checkout” button 610 to checkout as usual by submitting e-payment information to pay for the contents of the shopping cart. Or, the purchaser may select the “Shared Buy” button 620 to have one or more sharing payers contribute to the purchase. In one embodiment, selection of the “Shared Buy” button 620 causes a shared buy page, such as shared buy page 650 of FIG. 6B, to be displayed.

FIG. 6B illustrates a shared buy page 650 in accordance with an embodiment of the present invention. The shared buy page 650 includes radio buttons 655 selectable by the purchaser (the primary payer) to specify how the balance is to be allocated among prospective sharing payers. When the “split” radio button is selected, a drop-down box allows the primary payer to specify how many ways the balance is to be split. In the present example, the primary payer has indicated the balance is to be split 4 ways. Consequently, the primary payer (Ted Williams) is committing to be responsible for 25% of the balance, leaving 75% for 3 sharing payers.

When the “pledge” radio button is selected, the primary payer and subsequent sharing payers can pick an amount they would like to contribute to the total purchase price. A goal indicator 670, such as a fundraising or goal thermometer, may graphically depict the group's goal (the total purchase price) and the group's progress toward the goal.

The sharing payers can be notified of the opportunity to contribute to the purchase manually by the primary payer via an “out-of-band” communication (e.g., phone, text, email or the like) or via a mechanism provided by the e-commerce site. After the desired shared buy options have been selected, the primary payer may check out and pay his/her portion by selecting the “Proceed to Checkout” button 675. Various alternative implementations are contemplated. For example, the primary purchaser may be making a conditional purchase (i.e., purchase the items in the shopping cart only if one or more sharing payers make up the difference) or an unconditional purchase (i.e., purchase the items in the shopping cart regardless of whether one or more sharing payers contribute). In the case of a conditional purchase by the primary payer, the items may be held for a predetermined or configurable number of days to give sharing payers an opportunity to contribute to the purchase and may be shipped upon payment in full. In the case of an unconditional purchase by the primary payer, the remaining balance, if any, after giving sharing payers an opportunity to contribute, may be charged to the primary payer.

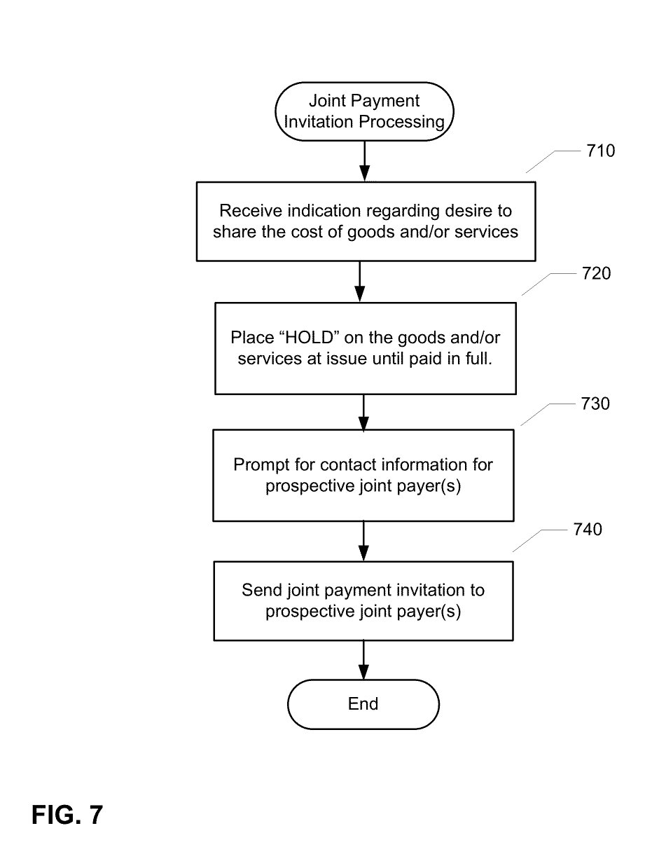

FIG. 7 is a flow diagram illustrating joint payment invitation processing according to one embodiment of the present invention. According to the present example, joint payment invitation processing begins with block 710. At block 710, an indication regarding a primary payer's desire to share the cost of goods and/or services is received by a payment module of an e-commerce site.

At block 720, a hold may be placed on the goods and/or services to delay activation/renewal of the service or shipping of the goods until the balance is paid in full. Such a hold is optional and dependent upon the particular implementation. For example, when a primary payer makes an unconditional purchase, the goods and/or services may be activated/renewed and/or shipped immediately.

At block 730, assuming an in-band communication to the prospective joint payers is to be generated, the primary payer is prompted for contact information (e.g., an email address or username within the e-commerce site) for prospective joint payers. Alternatively, the primary payer may directly notify prospective joint payers of the opportunity to contribute to the purchase at issue.

At block 740, the joint payment invitations are sent to the prospective joint payers. Typically, such invitations would be in electronic form (e.g., email or other electronic communication) and would include a link for the prospective joint payers to follow to register as joint payers; however, the invention is not so limited as a variety of alternative communication mechanisms may be used to invite prospective joint payers.

It is to be noted that while a “push” notification mechanism is described in connection with the current example, various “pull” mechanisms are also envisioned. For example, in the context of an online gift registry (for a wedding, baby shower, birthday or other occasion), those viewing the registry and desiring to purchase a gift for the registrant may contribute to the purchase of items identified as being the subject of a proposed shared buy.

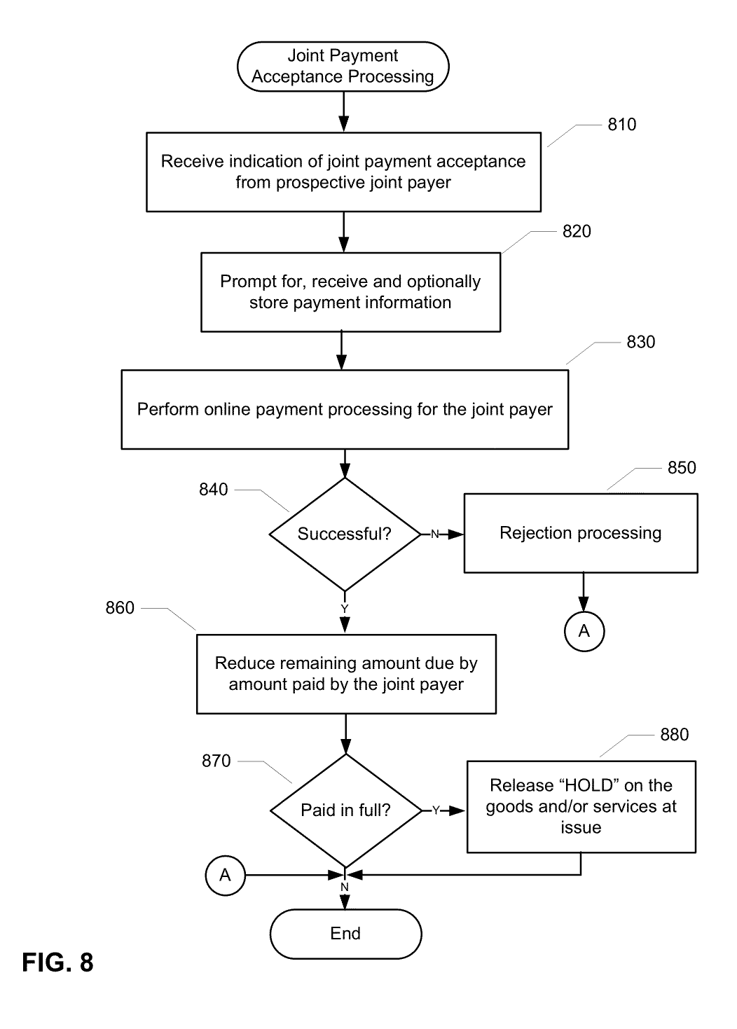

FIG. 8 is a flow diagram illustrating joint payment acceptance processing according to one embodiment of the present invention. According to the present example, joint payment acceptance processing begins with block 810. At block 810, a joint payment acceptance indication is received by the e-commerce site from a prospective joint payer. The acceptance indication may be in the form of the prospective joint payer following a link embedded within a notification email, for example.

At block 820, the e-commerce site prompts the joint payer for e-payment information and the commitment amount, receives same and optionally stores such information in a database (e.g., customer database 234) if it is to be used for a recurring subscription fee, for example.

At block 830, online payment processing is performed for the joint payer.

At decision block 840, it is determined whether the payment was processed successfully. If so, then processing continues with block 860; otherwise, processing branches to block 850.

At block 850, rejection processing is performed. As described above, various options exist for responding to an unsuccessful processing of a payment. For example, if the primary payer is to remain primarily responsible for the transaction at issue, then the amount of the payment that was not processed successfully can be added to the balance to be paid by the primary payer. Additionally, a notification (e.g., email or paper-based) may be sent to one or both of the joint payer and the primary payer.

At block 860, upon successful payment processing, the remaining amount due is reduced by the amount paid by the joint payer. Additionally, any goal indicator (e.g., goal indicator 670) associated with the purchase is updated to reflect the newly received payment.

At decision block 870, it is determined whether the purchase is paid in full. If not, joint payment acceptance processing is complete. If so, then at block 880, any hold on the goods and/or services at issue may now be released and joint payment acceptance processing is complete.

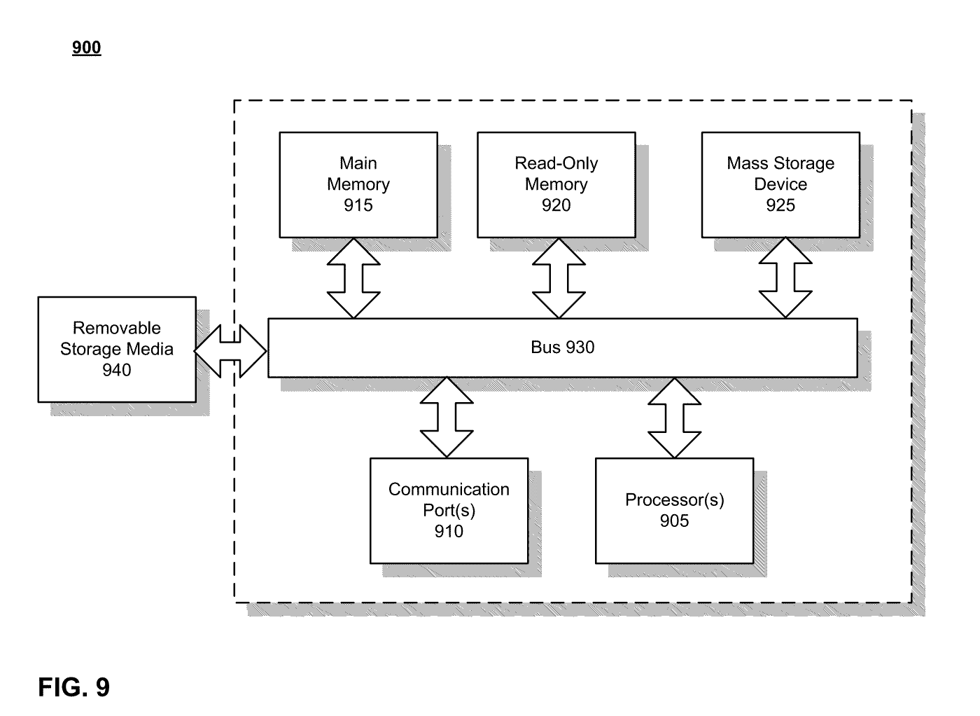

FIG. 9 illustrates a computer system 900 suitable for use, in accordance with an embodiment of the present invention. The computer system 900 may represent an exemplary client (e.g., client 210,) or server (e.g., server 230) used in connection with an e-commerce transaction. According to FIG. 9, the computer system includes at least one processor 905, at least one communication port 910, a main memory 915, a read only memory 920, a mass storage 925, a bus 930, and a removable storage media 940.

Exemplary processor(s) 905 can be an Intel® Itanium® or Itanium 2® processor(s) or AMD® Opteron® or Athlon MP® processor(s). Communication port(s) 910 can be any of an RS-232 port for use with a modem based dialup connection, a 10/100 Ethernet port, or a Gigabit port using copper or fiber. Communication port(s) 910 may be chosen depending on a network such a Local Area Network (LAN), Wide Area Network (WAN), or any network to which the computer system 900 connects.

Main memory 915 can be Random Access Memory (RAM), or any other dynamic storage device(s) commonly known in the art.

Read only memory 920 can be any static storage device(s) such as Programmable Read Only Memory (PROM) chips for storing static information such as instructions for processor 905.

Mass storage 925 can be used to store information and instructions. For example, hard disks such as the Adaptec 8 family of SCSI drives, an optical disc, an array of disks such as RAID, such as the Adaptec family of RAID drives, or any other mass storage devices may be used.

Bus 930 communicatively couples processor(s) 905 with the other memory, storage and communication blocks. Bus 930 can be a PC1 IPCI-X or SCSI based system bus depending on the storage devices used.

Removable storage media 940 can be any kind of memory card, flash memory stick, external hard-drives, floppy drives, IOMEGA 8 Zip Drives, Compact Disc—Read Only Memory (CD-ROM), Compact Disc—Re-Writable (CD-RW), Digital Video Disk—Read Only Memory (DVD-ROM). It is to be noted that the aforementioned examples do not limit the scope of the invention and are only exemplary embodiments.

What is claimed is:

1. A method comprising:
receiving, by a computer system of a communication service provider, payment information from a first member of a caregroup that shall serve as a primarily responsible individual for periodic service fees associated with communication services provided by the communication service provider to a digital mailbox appliance of a second member of the caregroup; and
enabling, by the computer system, the periodic service fees to be shared by other members of the caregroup by allowing one or more of the other members of the caregroup to commit to payment of a portion of the periodic service fees as secondarily responsible individuals.
